(19) United States
(12) Patent Application Publication
(10) Pub. No.: US 2004/0159451 A1
(43) Pub. Date: Aug. 19, 2004

(54) Air intake and exhaust device for a pistol type air impact wrench

(76) Inventor: Koji Taga, Iruma-gun (JP)

Correspondence Address: JORDAN AND HAMBURG LLP, 122 EAST 42ND STREET, SUITE 4000, NEW YORK, NY, 10168, US

(21) Appl. No.: 10/777,447

(22) Filed: Feb. 11, 2004

(30) Foreign Application Priority Data
Feb. 14, 2003 (JP) UM2003-683

(51) Int. Cl. B27C 3/08

(52) U.S. Cl. 173/169

(57) ABSTRACT

An improved air intake and exhaust device for a pistol type air impact wrench which does not discharge its exhaust air into the atmosphere directly from the end of its handle, but discharges it into the atmosphere at a considerable distance from the end of its handle to prevent any dust, etc. from rising at the site of work and any noise from being produced and thereby improve the working environment. In an air in-take and exhaust device for a pistol type air impact wrench having at the end of its handle an intake port and an exhaust port for compressed air for operating an air motor, a silencing bellows tube surrounding an air intake tube connected to the intake port is attached to the end of the handle and the silencing bellows tube and the air intake tube define an annular passage therebetween as an air exhaust passage.

### BACKGROUND OF THE INVENTION

1. Field of the Invention

This invention relates to an air intake and exhaust device for a pistol type air impact wrench. More particularly, it relates to an improvement in the air intake and exhaust device which prevents noise made by exhaust air discharged from the end of a handle forming an integral part of the housing of a pistol type air impact wrench, or dust produced by the exhaust air around the hand of a person working with it.

2. Description of Related Art

A known pistol type air impact wrench has its exhaust air discharged from the end of is handle close to the hand of a person working with it, as described in U.S. Pat. No. 3,605,914. Its force is so strong that its scattering of dust, etc. has unavoidably brought about a worse working environment.

### SUMMARY OF THE INVENTION

It is, therefore, an object of this invention to provide an air intake and exhaust device for a pistol type air impact wrench which does not discharge its exhaust air into the atmosphere directly from the end of its handle, but discharges it into the atmosphere at a considerable distance from the end of its handle to prevent any dust, etc. from rising at the site of work and any noise from being produced and thereby improve the working environment.

The above object is attained according to this invention by an air intake and exhaust device for a pistol type air impact wrench having at the end of its handle an intake port and an exhaust port for compressed air for operating an air motor, wherein a silencing bellows tube surrounding an air intake tube connected to the intake port is attached to the end of the handle and the silencing bellows tube and the air intake tube define an annular passage therebetween as an air exhaust passage.

The air intake tube is preferably connected by a hose adapter to the other end of a connecting tube fitted at one end in the intake port formed at the end of the handle.

The connecting tube preferably has an externally threaded portion for connection with the intake port at one end and an externally threaded portion for connection with the hose adapter at the other end.

Moreover, it is preferable that the silencing bellows tube be attached to one end of a deflector cover attached to the end of the handle with a packing disposed therebetween, while the deflector cover is attached by inserting it about the connecting tube fitted in the handle, holding it against the packing at the end of the handle and bringing the hose adapter into threaded engagement with the connecting tube.

### BRIEF DESCRIPTION OF THE DRAWINGS

FIG. 1 is a sectional view of an air intake and exhaust device for a pistol type air impact wrench embodying this invention; and

FIG. 2 is an exploded perspective view of the air intake and exhaust device shown in FIG. 1.

### DETAILED DESCRIPTION OF THE INVENTION

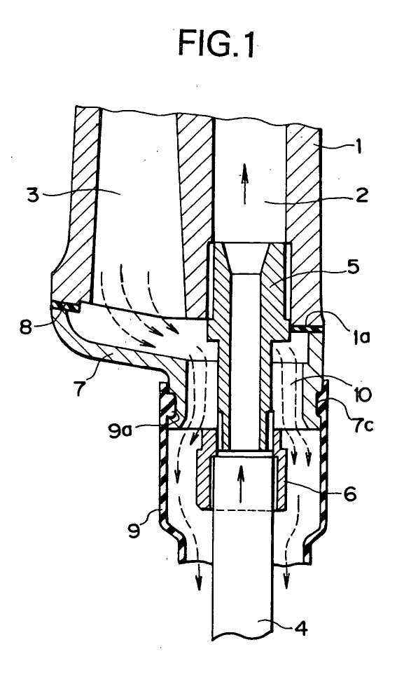

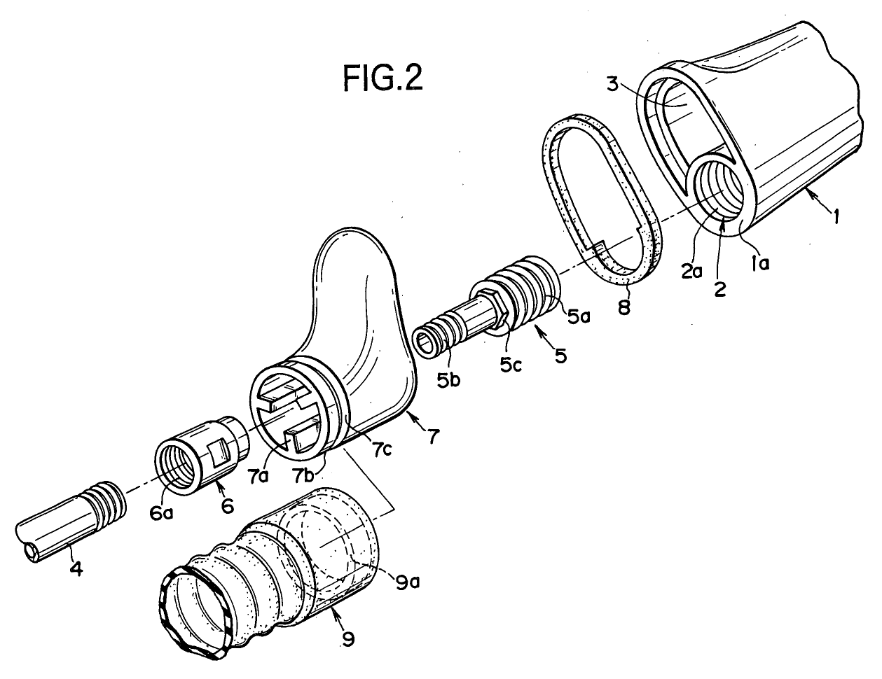

Description will now be made in detail of an embodiment of this invention with reference to the drawings. FIG. 1 is a sectional view of an air intake and exhaust device for a pistol type air impact wrench embodying this invention, and FIG. 2 is an exploded perspective view of the air intake and exhaust device shown in FIG. 1. In FIG. 1, 1 is a handle forming an integral part of the housing of a pistol type air impact wrench. The handle 1 has an intake port 2 and an exhaust port 3 formed at its end 1a. 5 is a connecting tube connecting the intake port 2 and an air intake tube 4. The connecting tube 5 is provided with a hose adapter 6 by which the air intake tube 4 is connected with the connecting tube 5.

7 is a deflector cover attached to the end 1a of the handle 1 with a packing 8 disposed therebetween, and is, for example, an aluminum die casting. 9 is a silencing bellows tube made of a synthetic resin. The deflector cover 7 has at its end engaging the handle substantially the same shape with the contour of the end 1a of the handle 1, while its opposite end is cylindrical and the silencing bellows tube 9 is attached to its cylindrical portion.

The device is constructed as described above, and exhaust air arriving from an air motor (not shown) in the housing of the pistol type air impact wrench is discharged through the exhaust port 3 in the handle 1, and through an annular passage 10 defined between the deflector cover 7 and the connecting tube 5 into the silencing bellows tube 9, as shown by broken lines in FIG. 1.

The intake port 2 formed in the end 1a of the handle 1 has an internally threaded portion 2a which is engageable by an externally threaded portion 5a formed at one end of the connecting tube 5. The connecting tube 5 having the externally threaded portion 5a at one end has at the other end an externally threaded portion 5b of smaller diameter for connecting the hose adapter 6. The connecting tube 5 has a hexagonal portion 5c formed in its mid-portion for use when the connecting tube 5 is threaded secured in the internally threaded portion 2a of the handle 1.

The deflector cover 7 is shaped like a boot and is hollow. At one end, it has a contour substantially equal to that of the end 1a of the handle 1, and is attached to it with the packing 8 of a resin disposed therebetween. While the deflector cover 7 is hollow, the example shown in the drawings has a plurality of ribs 7a formed axially on the inner surface of its portion to which the silencing bellows tube 9 is attached, and the smaller diameter externally threaded portion 5b of the connecting tube 5 extends through its portion having the ribs 7a.

For attaching the deflector cover 7, the connecting tube 5 is first threaded secured with the internally threaded portion. 2a, then the deflector cover 7 is held against the end 1a of the handle 1 with the packing 8 disposed therebetween, and an internally threaded portion 6a formed in the hose adapter 6 is threaded secured with the externally threaded portion 5b of the connecting tube 5 extending along the ribs 7a, as shown in FIG. 1. As a result, the annular passage 10 is defined about the connecting tube 5.

The silencing bellows tube 9 is a soft resin product and has an attaching end fitted about the cylindrical portion 7b formed at the end of the deflector cover 7, secured by an annular ridge 9a formed at its attaching end and fitted in an annular groove 7c formed about the deflector cover 7, and tightened by a snap ring, etc., if required.

The air intake and exhaust device for a pistol type air impact wrench according to this invention has a silencing bellows tube attached to the end of the handle and an annular exhaust passage defined between the air intake tube and the silencing bellows tube, as described above in detail. Therefore, exhaust air is not released directly at the very site of work, but is discharged at a distance equal to the length of the silencing bellows tube without raising any dust, etc. at or near the site and thereby worsening the working environment. Moreover, as exhaust air is released into the atmosphere after flowing a certain distance through the silencing bellows tube, the noise made when it is released is reduced, advantageously contributing to an improved working environment.

What is claimed is:

1. An air intake and exhaust device for a pistol type air impact wrench having at the end of its handle an intake port and an exhaust port for compressed air for operating an air motor, wherein a silencing bellows tube surrounding an air intake tube connected to the intake port is attached to the end of the handle and the silencing bellows tube and the air intake tube define an annular passage therebetween as an air exhaust passage.

2. The air intake and exhaust device for a pistol type air impact wrench according to claim 1, wherein the air intake tube is connected by a hose adapter to the other end of a connecting tube fitted at one end in the intake port formed at the end of the handle.

3. The air intake and exhaust device for a pistol type air impact wrench according to claim 2, wherein the connecting tube has an externally threaded portion for connection with the intake port at one end and an externally threaded portion for connection with the hose adapter at the other end.

4. The air intake and exhaust device for a pistol type air impact wrench according to claim 2, wherein the silencing bellows tube is attached to one end of a deflector cover attached to the end of the handle with a packing disposed therebetween.

5. The air intake and exhaust device for a pistol type air impact wrench according to claim 4, wherein the deflector cover is attached by inserting it about the connecting tube fitted in the handle, holding it against the packing at the end of the handle and bringing the hose adapter into threaded engagement with the connecting tube.
